(19) United States
(12) Patent Application Publication
(10) Pub. No.: US 2004/0052620 A1
(43) Pub. Date: Mar. 18, 2004

(54) Apparatus for storing and retrieving articles

(76) Inventor: Jurgen Schieleit, Bargteheide (DE)

Correspondence Address: WHITE & CASE LLP, PATENT DEPARTMENT, 1155 AVENUE OF THE AMERICAS, NEW YORK, NY, 10036, US

(21) Appl. No.: 10/414,315

(22) Filed: Apr. 15, 2003

(30) Foreign Application Priority Data
Apr. 19, 2002 (DE) 202 06 257.0

(51) Int. Cl. B65G 1/06

(52) U.S. Cl. 414/281; 414/267

(57) ABSTRACT

A storing apparatus has at least one rack with compartments that are arranged in an essentially vertical plane in a matrix having a first direction and a second direction relative to each other. A carrier frame, disposed facing the rack, moves vertically in a first conveying arrangement. At least one second conveying arrangement is fitted to the frame to accept an article and move the article in a first direction to any one of the compartments in the rack. At least one third conveying arrangement moves the article between the second conveying arrangement and a compartment.

The present invention relates to an apparatus for storing articles in a rack and retrieving them therefrom.

The storage of articles is a recurrent necessity for the purpose of providing merchandise or spare parts, for example, in a factory. For this purpose, it is known for piece goods, component parts or packaging units, in particular, to be stored in a sorted state in racks. The original operations of storing and retrieving the articles by hand—using ladders to span a number of rack levels—have given rise, in the course of automation, to logistical apparatuses and processes that are capable of storing and retrieving even heavy storage articles over large rack surface areas and considerable rack heights. In this respect, fork-lift trucks may be mentioned here by way of example. Also known are programmable logistical apparatuses, in which a computer numerical control (CNC) system selects a compartment, corresponding to the program, and a robot-like apparatus then carries out the programmed logistical step.

The disadvantage with the known systems is that it is usually only possible for the compartments of a rack surface to be accessed essentially in sequence. This is because, in order to avoid collisions, a second storage or retrieval apparatus has to wait in front of a rack surface until a first storage or retrieval apparatus that is already operating there has completed its task. Or high-outlay control and coordination programs are necessary in order to avoid collisions if a plurality of such apparatuses are operating at the same time. The use of such known apparatuses for storing and retrieving articles consequently results in disadvantageously long waiting times if a necessarily high throughput leads to articles that are to be stored being supplied in an excessively rapid manner and/or to articles that are to be retrieved being removed in an excessively rapid manner. In order to eliminate these disadvantages, the prior art has only disclosed apparatuses with particularly high travel speeds, or apparatuses with accompanying magazines or with multiple receiving means for the supplied parts, in particular in storage systems for small parts.

The object of the present invention is to provide an apparatus that is intended for storing articles in a rack and retrieving them therefrom and that further accelerates the storage and retrieval operations to a considerable extent.

This object is achieved by an apparatus having the features of claim 1. Preferred configurations are specified in the subclaims.

According to the invention, the apparatus has at least one rack with compartments that are arranged in an essentially vertical plane in a matrix in a first direction and a second direction in relation to one another. The compartments are thus located essentially one above the other and one beside the other, to be precise preferably vertically and horizontally, so to speak, in columns and rows. A first conveying arrangement of the apparatus according to the invention has a carrying frame that can be displaced, by means of the conveying arrangement, in a first direction—to be precise, preferably as a lifting arrangement, in the vertical direction—in front of the compartments in an essentially vertical plane—that is to say, so to speak, “in front of the rack” on a side from which the compartments are accessible. Fitted on the carrying frame according to the invention is at least one second conveying arrangement, by means of which the articles can be conveyed in a second direction—in the preferred embodiment with the lifting arrangement as first conveying arrangement, then, by means of horizontally running conveyors (e.g. conveying belts, although, for example, roller conveyors are also a conceivable alternative)—in the above-mentioned essentially vertical plane “in front of the rack.” Preferably at least two second conveying arrangements are arranged in series and thus form a conveying line. This means that an article transported by one of the second conveying arrangements can be received by the next second conveying arrangement, adjoining the first-mentioned second conveying arrangement in the conveying line, and transported further. It is thus also possible for a conveying line to be formed by more than two second conveying arrangements, to be precise, preferably by as many conveyors as the rack has compartments located one beside the other, that is to say “columns.”

More than a third conveying arrangement then, according to the invention, transports the article between the second conveying arrangement and a compartment in front of which the article has been positioned by means of the first and second conveying arrangements. The apparatus preferably has as many third conveying arrangements as the rack has compartments in the second direction, in which the second conveying arrangements convey the articles. In the preferred configuration of the invention with the first conveying arrangement as lifting arrangement and the second conveying arrangements as conveying belts arranged in series, then, preferably each compartment “column” is assigned a third conveying arrangement, which is preferably likewise fitted on the carrying frame.

Alternatively, it is also possible for the apparatus to have fewer third conveying arrangements than columns, it then being possible for these themselves to be moved in the second direction in order to be able to store articles in each compartment “column.”

A preferred configuration of the apparatus according to the invention with double storage capacity is distinguished by two racks that are each arranged on one side of the conveying plane of the first and second conveying arrangements. In the case of compartments of the two racks thus having their access sides located opposite one another, each third conveying arrangement, in one direction, can transport an article between the second conveying arrangement and a compartment of one rack and, in the other direction, can transport an article between the second conveying arrangement and a compartment of the other rack.

In order to ensure that each compartment can be reached by means of the apparatus according to the invention, the conveying path of the first and second conveying arrangements preferably extends both in the first direction and in the second direction over the entire rack surface.

In particular in the case of the particularly preferred configuration, in the case of which the apparatus according to the invention has as many second conveying arrangements as compartments in the second direction, the storage and retrieval speed of the apparatus according to the invention is considerable, which is particularly clear with reference to the following description of the attached figures.

The present invention is described herein below with reference to the attached figures, in which:

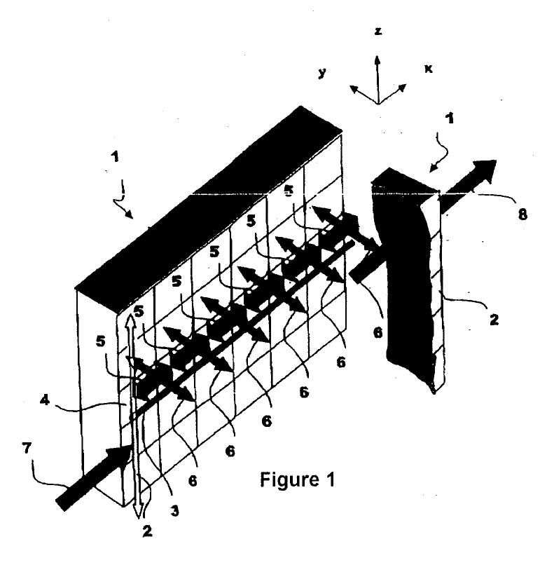

FIG. 1 shows a three-dimensional schematic view of an apparatus according to the invention with two racks, of which one is illustrated in cut-away form, the conveying arrangements of the apparatus being indicated merely by arrows which indicate the respective conveying path,

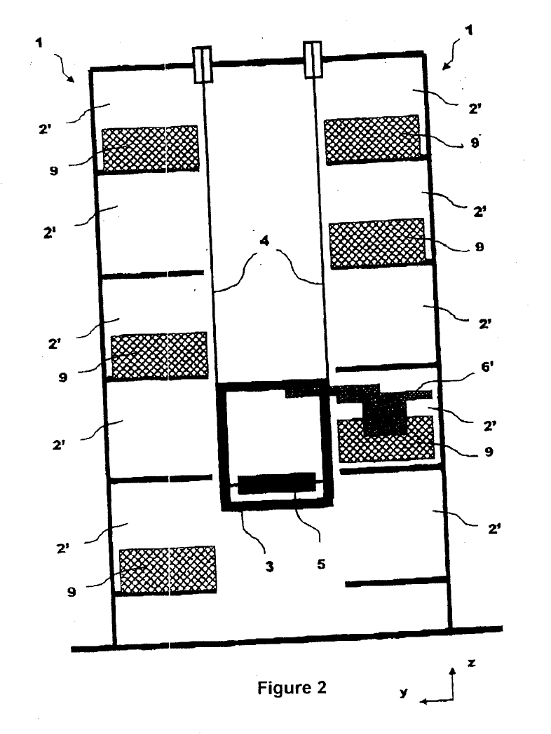

FIG. 2 shows, schematically, a cross section through the apparatus according to FIG. 1,

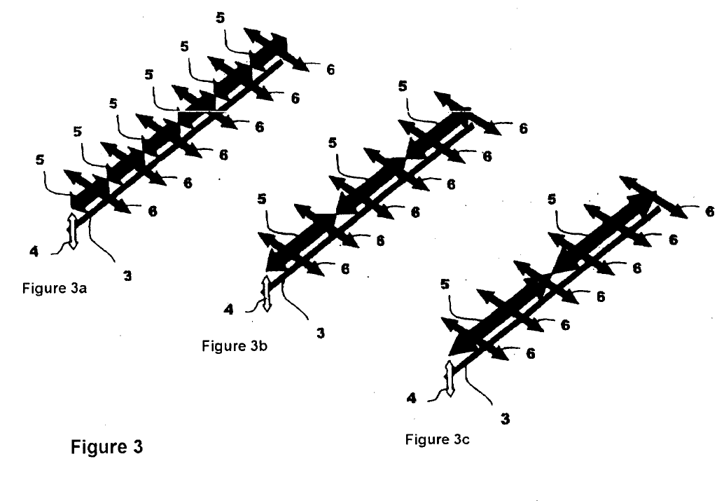

FIG. 3a shows, in the same elevation and by the same method of illustration as FIG. 1, the first, second and third conveying arrangements according to FIG. 1,

FIG. 3b shows, in the same elevation and by the same method of illustration as FIG. 1, an alternative configuration of the first, second and third conveying arrangements,

FIG. 3c shows, in the same elevation and by the same method of illustration as FIG. 1, a further alternative configuration of the first, second and third conveying arrangements,

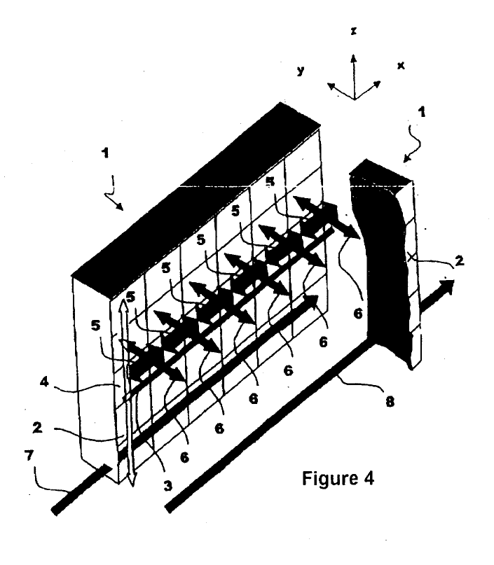

FIG. 4 shows, in the same elevation and by the same method of illustration as FIG. 1, a configuration of the apparatus according to the invention from FIG. 1 which has an alternative feeding and removal means,

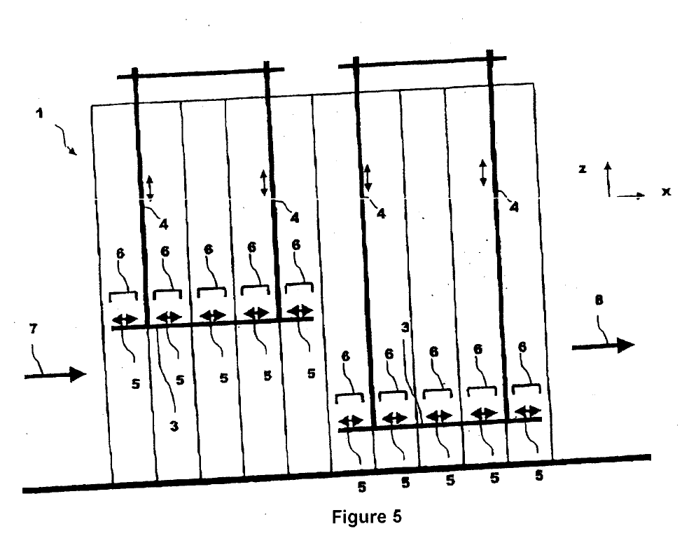

FIG. 5 shows a plan view of the access plane of the racks of two apparatuses according to the invention that are connected in series, and

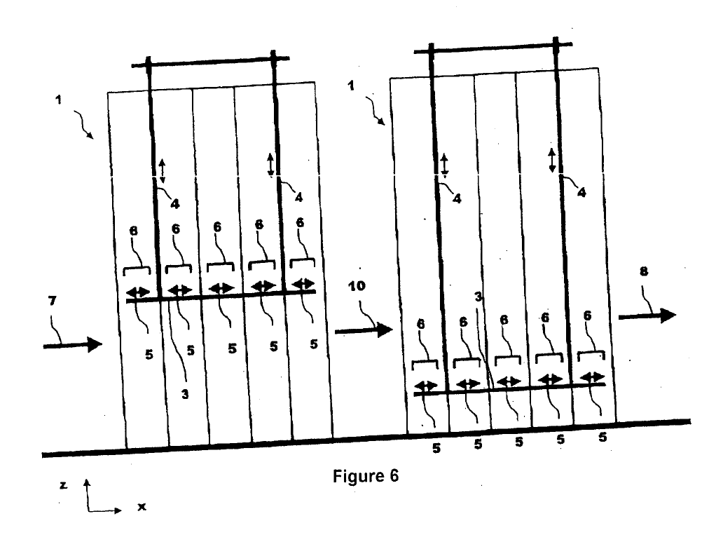

FIG. 6 shows, in the same elevation and by the same method of illustration as FIG. 5, an alternative arrangement of the two series-connected apparatuses according to the invention.

A carrying frame 3 is located, according to FIG. 1, in a storage region 1, e.g. of an aisle, comprising two racks 1 that are subdivided into different compartments 2. The carrying frame 3 may be displaced in a preferably computer-controlled manner, by means of a first conveying arrangement or lifting arrangement 4, in the z-direction in relation to the arrangement of the compartments 2. Six second conveying arrangements or conveying elements 5 are arranged in series on the carrying frame 3 and can move articles (not illustrated in FIG. 1) in the x-direction. The conveying elements 5 are assigned third conveying arrangements or transfer elements 6. Each transfer element 6 can receive an article and move the latter in the y-direction and thus move it into the compartment 2 and receive it therefrom. Depending on the technical configuration, it is possible for the transfer element 6, for the receiving and setting-down operations, to execute a small movement in the z-direction or a gripping movement. It is possible for the conveying element 5 and transfer element 6, depending on the technical configuration, to form a structural unit.

Since none of the transfer elements 6 is intended to execute a movement in the x-direction, in each case one transfer element 6′, as is illustrated in FIG. 2 (sectional view during the operation of storing an article 9), is always assigned here to all of the compartments 2′ with an identical x-coordinate, that is to say to the two mutually opposite rack columns into which the transfer element 6′ can move.

The transfer element 6 and the conveying element 5 may be assigned to one another in different numerical ratios. FIG. 3 shows transfer elements 6 assigned to conveying elements 5, for example, in the ratios 1:1 (FIG. 3a), 2:1 (FIG. 3b) and 3:1 (FIG. 3c). In the case of ratios greater than 1:1, the design outlay is indeed reduced, but there are restrictions to the ways in which the storage or retrieval operations may proceed, because the articles are transported and distributed on the conveying elements 5 at less precise intervals and thus in a less flexible manner.

A storage cycle, in the case of which all processes may be automatically controlled, proceeds as follows:

Once the carrying frame 3 has been placed in the receiving position, articles 9 are fed to the conveying elements 5 via a feeding means 7, with the result that articles 9 are located at a minimum of one transfer element 6 and at a maximum of all of the transfer elements 6. In this case, the articles 9 move on the conveying elements 5 and from conveying element 5 to conveying element 5. Once all the articles 9 that are to be stored have left the feeding means 7, the carrying frame 3 moves, by means of the lifting arrangement 4, to the compartment level assigned to it by the control means, i.e., in front of those compartments 2 which all have the same predetermined z-coordinate. This is the rack row selected by the control means. The operation of storing individual articles 9, or all of the articles 9, in the compartments then takes place by means of the corresponding transfer elements 6. At the minimum, the lifting apparatus 4 positions the carrying frame 3, for storing all of the articles 9 received from the feeding means 7 (e.g., n items), just once per cycle, that is to say if all the articles 9 are to be stored in one rack row. At the maximum, the lifting apparatus 4 positions the carrying frame 3, for storing all of the articles 9 (e.g., n items), n times per cycle, that is to say if each article 9 is to be stored on a different z-level (rack row). By virtue of it being possible for the articles 9 to be transferred from conveying element to conveying element 5, the articles 9 may also be stored, in a single storage cycle, in compartments 2′ located directly one above the other. It is thus even possible for all of the compartments that are to be accessed, as illustrated in FIG. 2 for example, to be located in one rack column.

Automatically controlled retrieval operations may also be carried out in a manner corresponding to the storage operation. Depending on the control strategy, it is also possible for combinations of storage and retrieval operations to be carried out during a single cycle. A removal means 8 serves for transporting the articles 9 away from the conveying elements 5, it being possible for the feeding means 7 and removal means 8 to be identical, i.e., in which case a combined feeding and removal means functions in reversing operation.

All that has been described above results in the following particular advantages of the system:

The integrated storage and transporting system makes it possible for two mutually opposite rack columns to be assigned one transfer element 6, it being possible for articles 9, by means of the conveying elements 5, to change over between the transfer elements 6 and thus between the rack columns. Extremely high storage and retrieval rates can be achieved as a result. If each transfer element 6 is assigned a conveying element 5, moreover, there are no restrictions in respect of the conveying elements 5 being filled completely. That is to say, prior to the start of a storage cycle, it is possible for all of the transfer elements 6 to contain articles 9 irrespective of the location of free compartments 2 for the articles 9. The same applies to the retrieval operation.

If the system is configured such that, as is illustrated in FIG. 1, the feeding means 7 and removal means 8 are located on opposite sides, that is to say upstream of the start of the aisle and downstream of the end of the aisle, then the conveying elements 5 may be filled and emptied at the same time, i.e., articles that are to be removed leave the system via the removal means 8, while infeed via feeding means 7 may be started at the same time. In addition, or as an alternative, it is also possible for the feeding means 7 and removal means 8 to be integrated within the space of the bearing region 1—e.g., as conveying sections that are located in each case in one rack row, regardless of the z-level with the result that the articles are received via the transfer elements 6 rather than via the conveying elements 5 (FIG. 4). This variant is particularly successful for parallel charging, if the carrying frame 3 is to be a very long structure.

A further special feature of this system is that, in one aisle, it is possible for a plurality of carrying frames 3 to be used one beside the other on independent lifting arrangements 4 (FIG. 5). It is possible for articles 9 to be received between conveying elements 5 of adjacent carrying frames 3 whenever the latter are positioned on a level with the same z-coordinate. Additional intermediate conveyors 10 (FIG. 6), however, also make it possible for adjacent carrying frames 3 in each case to be separated from one another in space. This makes it possible to achieve, for example, better access for maintenance purposes.

1. An apparatus for storing and retrieving articles, having
at least one rack with compartments that are arranged in an essentially vertical plane in a matrix with a first direction and a second direction in relation to one another,
a first conveying arrangement, with a carrying frame which can be displaced, by means of the first conveying arrangement, in the first direction in an essentially vertical plane in front of the compartments,
at least one second conveying arrangement, which is fitted on the carrying frame and is intended for conveying the articles in the second direction in the essentially vertical plane in front of the compartments,
and more than one third conveying arrangement, for conveying the articles between the second conveying arrangement and a compartment.

2. The apparatus as claimed in claim 1, wherein
the compartments are arranged in horizontal rows and vertical columns in relation to one another, wherein
the first conveying arrangement is a lifting arrangement which displaces the carrying frame in the vertical direction, and wherein
the at least one second conveying arrangement is a conveying belt which displaces the article in the horizontal direction.

3. The apparatus as claimed in one of the preceding claims, which comprises as many third conveying arrangements as rack columns, and wherein each third conveying arrangement is fitted on the carrying frame in a manner in which it is assigned to one rack column.

4. The apparatus as claimed in one of the preceding claims, which comprises at least two second conveying arrangements which, arranged in series, form a conveying line.

5. The apparatus as claimed in one of the preceding claims, which comprises as many second conveying arrangements as rack columns.

6. The apparatus as claimed in one of the preceding claims, wherein the first and the second conveying arrangements can be displaced in the relevant direction over the entire extent of the rack.

7. The apparatus as claimed in one of the preceding claims, which comprises two racks that are each arranged on one side of the vertical plane.
